(19) United States
(12) Patent Application Publication
(10) Pub. No.: US 2007/0207234 A1
(43) Pub. Date: Sep. 6, 2007

(54) Cutting Tool for Machining Foodstuff Ball

(76) Inventor: Jixian Li, Hebei Province (CN)

Correspondence Address: KAPLAN GILMAN GIBSON & DERNIER L.L.P., 900 ROUTE 9 NORTH, WOODBRIDGE, NJ, 07095, US

(21) Appl. No.: 10/575,399

(22) PCT Filed: Sep. 17, 2004
(86) PCT No.: PCT/CN04/01054

§ 371 Date: Jan. 9, 2007

(30) Foreign Application Priority Data
Oct. 9, 2003 (CN) 2003201000646

(51) Int. Cl. A47J 43/20

(52) U.S. Cl. 425/281

(57) ABSTRACT

The invention relates to a cutting tool for machining foodstuff, which can be rotated to form the foodstuff into a ball. The cutting tool consists of a main rod body with a handle and a semi-spherical bowl with blade. A connection part is mounted between the main rod body and the semi-spherical bowl with blade. The end face of the bowl with blade and the axis of the main rod body lie at 45-60 degrees. The holes with any geometrical shape are provided on the semi-spherical surface of the bowl with blade. The peripheries of the holes are formed as blades for cutting, which can remove the unnecessary part of the foodstuff to be formed as a ball. By using the cutting tool, a smoother and more beautiful foodstuff ball can be obtained.

### TECHNICAL FIELD

The invention relates to a cutting tool for machining foodstuff, and more particularly, to a cutting tool for machining foodstuff, which can be rotated to form the foodstuff into a ball. By using the cutting tool, perfect ball products can be obtained from relatively hard vegetable and fruit.

### DESCRIPTION OF THE PRIOR ART

It's usually necessary for foodstuff and dining industries to provide products with figuration which are formed by the cutting tools for figuration. Nowadays, there are various kinds of cutting tools for machining foodstuff, such as vegetable or fruit, for figuration. For the purpose of machining stuff into balls, the cutting tool is now configured into a semi-spherical bowl with blade, of which a small hole, named as the gas-releasing hole, is opened on the top of the semi-spherical surface to release gas during operation for making products with figuration. The axis of the handle of the cutting tool is linearly parallel to the axis of the semi-spherical bowl with blade. Therefore, the resistance during operation is relatively strong, the force can not be applied reasonably, and the operation is extremely inconvenient. Furthermore, the bowl with blade can not be inserted into the portion best for obtaining balls of the stuff. In addition, the ball products provided thereby are not very round so that the appearances of product are not very good.

### SUMMARY OF THE INVENTION

The object of the invention is directed to solve the above-stated disadvantages in the prior art, provides an improved cutting tool for machining foodstuff ball, which can be inserted into the portion best for obtaining balls of the stuff. Therefore, the operation is convenient and perfect ball products can be obtained from relatively hard vegetable or fruit.

For achieving the object of the invention, the cutting tool for machining foodstuff ball of the invention comprises a main rod body with a handle and a semi-spherical bowl with blade, wherein a connection part is mounted between the main rod body and the semi-spherical bowl with blade, the end face of the semi-spherical bowl with blade and the axis of the main rod body lie at 45-60 degrees, holes with any geometrical shape are provided on the semi-spherical surface of the semi-spherical bowl with blade, furthermore, the around brims of the holes are formed as blades for cutting, the blades are provided in such a manner that the unnecessary part of the foodstuff to be formed as a ball can be removed and a smoother, rounder and good-looking foodstuff ball can be obtained.

For the purpose of enough rigidity of the semi-spherical cutting tool, it's preferable that the sum of areas of the holes provided thereon is generally no more than 75% of the whole area of the semi-spherical surface of the semi-spherical bowl with blade, and most preferably no more than 60%. The orientation of the blades on the around brims of the holes are preferably consistent with that of the blades for cutting on the around brims of the semi-spherical bowl with blade. The blades on the around brims of the holes are formed as an oblique blade, a right-angle blade or a combination of an oblique blade and a right-angle blade.

The structure of the cutting tool according the invention will be described below in further details with reference to preferred embodiments taken in conjunction with the accompanying drawings, so that the effect owing to the features provided in the invention will become more apparent.

### BRIEF DESCRIPTION OF THE DRAWINGS

FIG. 1 shows a schematic view illustrating the cutting tool for machining foodstuff ball according to the invention.

FIG. 2 shows a schematic view illustrating the semi-spherical bowl with blade and the holes formed thereon according to an embodiment.

FIG. 3 shows a schematic view illustrating the semi-spherical bowl with blade and the holes formed thereon according to another embodiment.

FIG. 4 shows a schematic view illustrating the semi-spherical bowl with blade and the holes formed thereon according to still another embodiment.

FIG. 5 shows a schematic view illustrating the semi-spherical bowl with blade and the holes formed thereon according to yet another embodiment.

### DESCRIPTION OF THE PREFERRED EMBODIMENTS

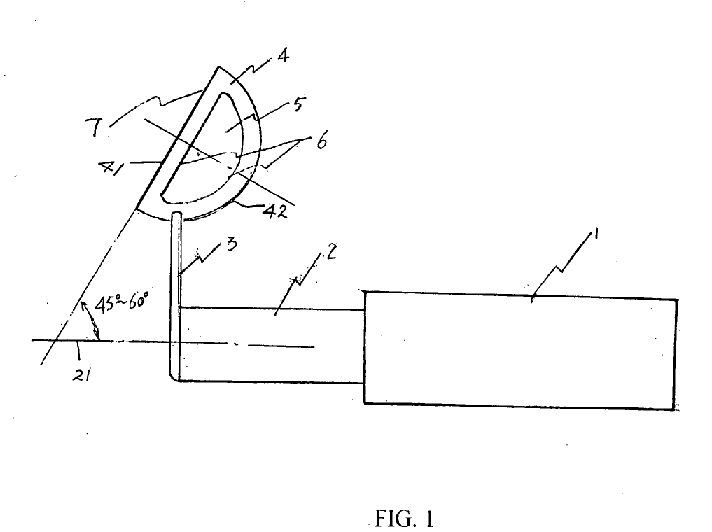

Firstly referring to FIG. 1, a cutting tool for machining foodstuff ball according the invention comprises a main rod body 2 with a handle 1 and a semi-spherical bowl 4 with blade, wherein a connection part 3 is mounted between the main rod body 2 and the semi-spherical bowl 4 with blade, the end face 41 of the semi-spherical bowl 4 with blade and the axis 21 of the main rod body 2 lie at 45-60 degrees, holes 5 with any geometrical shape are provided on the semi-spherical surface 42 of the semi-spherical bowl 4 with blade, the around brims of the holes are formed as blades 6 for cutting which can remove the unnecessary part of the foodstuff to be formed as a ball. Blades 7 are provided on the around brims of the semi-spherical bowl 4 with blade. The blades 7 are formed as an oblique blade, a right-angle blade or a combination of an oblique blade and a right-angle blade.

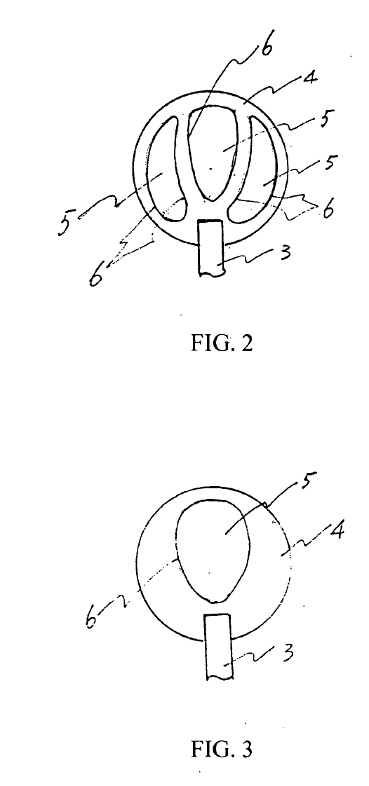

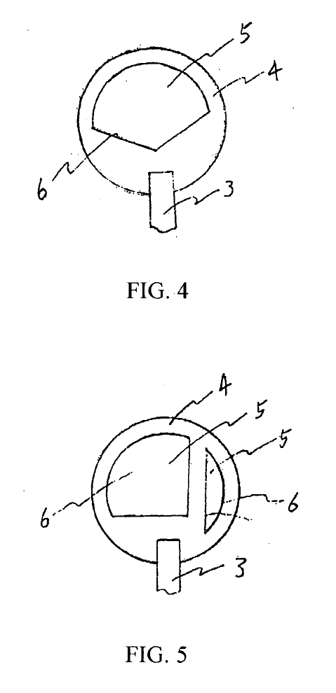

Referring to FIGS. 2 to 5, these drawings show the holes 5 with various geometrical shapes provided on the semi-spherical surface 42 of the semi-spherical bowl 4 with blade, and the around brims of the holes 5 are formed as blades 6. Particularly, as shown in FIG. 2, three holes are formed on the semi-spherical surface of the bowl 4 with blade wherein the hole 5 in the middle is shaped like a cone and the other two holes 5 on both sides are shaped like a banana. As shown in FIG. 3, a hole 5 shaped as pear is formed on the semi-spherical surface of the bowl 4 with blade. The hole 5 shown in FIG. 4 is in the shape of fan. As shown in FIG. 5, two holes 5 which are entirely different on both size and shape are formed on the semi-spherical surface of the bowl 4 with blade, wherein the big hole 5 is shaped as fan and the small hole 5 is shaped as arch. As for the invention, any number of holes 5 with any shape can be formed on the semi-spherical surface of the bowl 4 with blade of which holes the around brims are provided with blades 6 so long as it's allowed by the intensity and rigidity of the bowl 4 with blade.

For the purpose of enough rigidity of the semi-spherical bowl 4 with blade, it's preferable that the sum of areas of the holes 5 provided thereon is usually no more than 75% of the whole area of the surface of the semi-spherical bowl 4 with blade, and most preferably no more than 60% of the whole area of the surface of the semi-spherical bowl 4 with blade. The orientation of the blades 6 on the around brims of the holes 5 is preferably consistent with that of the blades for cutting on the around brims of the semi-spherical bowl 4 with blade.

During operation, the around brims 7 of the bowl 4 with blade are inserted into the vegetable stuff such as potato and the bowl 4 with blade is then rotated while cutting into the vegetable to obtain a smooth foodstuff ball from the vegetable to be machined.

The above-stated are the preferable embodiments of the invention, and any equivalent changes according to the spirit of the invention fall into the scope of the invention as hereinafter claimed.

1. A cutting tool for machining foodstuff ball comprising a main rod body (2) with a handle (1) and a semi-spherical bowl (4) with blade, is characterized in that a connection part (3) is disposed between the main rod body (2) and the semi-spherical bowl (4) with blade, the end face (41) of the semi-spherical bowl with blade and the axis of the main rod body (2) lie at 45-60 degrees, one or more holes (5) with geometrical shapes are provided on the semi-spherical surface (42) of the semi-spherical bowl with blade and the peripheries of the holes are provided with one or more blades (6) for cutting.

2. A cutting tool for machining foodstuff ball according to claim 1, is characterized in that the sum of areas of the holes provided on the semi-spherical bowl (4) with blade is no more than 75% of the whole area of the surface (42) of the semi-spherical bowl with blade.

3. A cutting tool for machining foodstuff ball according to claim 2, is characterized in that the sum of areas of the holes (5) provided on the semi-spherical bowl (4) with blade is no more than 60% of the whole area of the surface (42) of the semi-spherical bowl with blade.

4. A cutting tool for machining foodstuff ball according to claim 1, is characterized in that the orientation of the blades on the peripheries of the holes is consistent with that of the blades for cutting on the peripheries of the semi-spherical bowl with blade.

5. A cutting tool for machining foodstuff ball according to claim 1, is characterized in that blades (7) on the peripheries of the semi-spherical bowl are formed as an oblique blade, a right-angle blade or a combination of an oblique blade and a right-angle blade.

6. A cutting tool for machining foodstuff ball according to claim 1, is characterized in that the said holes (5) are formed in the shape of banana, fan, arch, pear or cone.
